(19) United States
(12) Patent Application Publication
(10) Pub. No.: US 2022/0049059 A1
(43) Pub. Date: Feb. 17, 2022

(54) WATER-BORNE CORE-SHELL POLYMERS, A METHOD FOR MAKING THE SAME AND THE APPLICATIONS THEREOF

(71) Applicant: BASF SE, Ludwigshafen am Rhein (DE)

(72) Inventors: Patrick Yan, Shanghai (CN); Yuan Liu, Shanghai (CN); Jian Feng Xia, Shanghai (CN); Noboru Yakura, Yokkaichi-shi (JP)

(21) Appl. No.: 17/414,179

(22) PCT Filed: Dec. 4, 2019
(86) PCT No.: PCT/EP2019/083648

§ 371 Date: Jun. 15, 2021

(30) Foreign Application Priority Data
Dec. 18, 2018 (CN) PCT/CN2018/121801

(51) Int. Cl. C08J 3/12; C09D 11/108

(52) U.S. Cl. CPC C08J 3/126; C08J 2325/08; C08J 2431/04; C09D 11/108

(57) ABSTRACT

Described herein are a water-borne core-shell polymer, a method for preparing the same, and the applications thereof. Also described herein is a water-borne styrene/vinyl acetate (St/Vae) core-shell polymer which is suitable for corrugated board ink applications. The water-borne emulsion containing the core-shell polymer shows superior covering property and color strength.

### FIELD OF THE INVENTION

The present invention is related to a water-borne core-shell polymer, a method for preparing the same and the applications thereof. In particular, the present invention is related to a water-borne styrene/vinyl acetate (St/Vae) core-shell polymer which is suitable for corrugated board ink applications. The present invention also discloses a method for making the same and the applications thereof.

### BACKGROUND OF THE INVENTION

Most of the commonly used inks for normal printing paper are not suitable to be applied onto to corrugated paper, due to significant unevenness of corrugated paper. Those inks show poor covering performance. Therefore, special inks are needed which have outstanding covering properties. And, binders are important components for inks, which include solvent-based binders and water-borne binders. Nowadays, due to the increasing awareness of environment protection and personal health, solvent-based binders are seldomly used. Many technical solutions have been proposed to create water-borne binders that have good covering property, such as opaque polymer binders.

CN105524201A discloses a water-borne polymer emulsion which has good covering properties and a process for making such. The polymer emulsion is synthesized with dimethyl itaconate, 2-(2-oxo-1-imidazolidinyl)ethyl methacrylate, (meth)acrylic acid and other acylates. The process involves the addition of many ingredient in different steps, which is rather complicated, and the resulted emulsion could only have comparable covering performance compared to commercial product.

Most of the polymer binders are based on styrene-acylate, styrene-butadiene, urethane-acrylate, polyvinyl alcohol or polyacrylate. Meanwhile, less attention has been paid to styrene-vinyl esters systems due to the intrinsic difficulties of polymerizing styrene with vinyl esters.

For example, U.S. Pat. No. 4,683,269A discloses a method for producing an opaque binder system by mixing homogeneous film-forming polymeric particles and heterogeneous core-shell polymeric particles. The homogeneous film-forming polymeric particles shall have a Tg of less than 45° C. while the heterogeneous core-shell polymeric particles shall have a core with Tg greater than 80° C. However, it's difficult to keep the mixed particles homogenously dispersion in water for a long time.

CN102134294A discloses (Example 1) discloses a core-shell polymer with good covering properties. The polymer contains a styrene-vinyl acetate core and an acylate shell. Example 2 discloses a system with styrene-acrylate core and acrylate shell while example 3 discloses a system with styrene core and acrylate shell. However, other systems have better performance compared to the styrene-vinyl acetate system (table 3).

Therefore, there is still a need for developing a better emulsion system with superior covering performance and is suitable for inks which may be applied onto corrugated paper.

### SUMMARY

One objective of the present invention is to develop a novel water-borne core-shell polymer which has superior covering property and outstanding color strength when applied as binder for inks. The core-shell polymer has a core:shell ratio (in weight) of 90:10 to 45:55. The weight percentage of vinyl esters in the shell is in the range of 20 wt % to 95 wt % while the weight percentage of styrene in the core is in the range of 70 wt % to 100 wt %, all based on the total weight of all the monomers used for the shell and the core, respectively.

Another objective of the present invention is to provide a process for making the water-borne core-shell polymer. The water-borne core-shell polymer was synthesized via multi-stage polymerization in aqueous solution.

A third objective of the present invention is to provide an application of the water-borne core-shell emulsion as binders for inks, especially inks applicable on corrugated paper.

### DETAILED DESCRIPTION OF THE INVENTION

Unless otherwise specified, all terms/terminology/nomenclatures used herein have the same meaning as commonly understood by the skilled person in the art to which this invention belongs to.

Expressions “a”, “an” and “the”, when used to define a term, include both the plural and singular forms of the term.

The term “polymer” or “polymers”, as used herein, includes both homopolymer(s), that is, polymers prepared from a single reactive compound, and copolymer(s), that is, polymers prepared by reaction of at least two polymer forming reactive, monomeric compounds.

The term “core-shell polymer” means a polymer that has a core-shell structure which is synthesized with at least a first emulsion polymerization process and at least a second polymerization process. In the present invention, the monomer composition for the two polymerization processes are different from each other.

The designation (meth)acrylate and similar designations are used herein as an abbreviated notation for “acrylate and/or methacrylate”.

The term “styrene(s)” shall mean styrene itself and its derivatives as well. All percentages and ratios denote weight percentages and weight ratios unless otherwise specified.

The present invention relates to a water-borne core-shell polymer, which has outstanding covering properties and are suitable for ink applications. The core-shell polymer has a core:shell ratio (in weight) of 90:10 to 45:55. And, the weight percentage of vinyl esters in the shell polymer is in the range of 20 wt % to 95 wt % while the weight percentage of styrene in the core polymer is in the range of 70 wt % to 100 wt %, all based on the total weight of all the monomers used for the shell and the core respectively.

Vinyl esters are necessary monomers for the synthesis of the shell polymer while styrenes are necessary monomers for the core polymer. There is no specific requirement on the co-monomers for the shell polymer. But, for the stability of the polymer emulsion, at least one more hydrophilic monomer must be presented as the monomer for the shell polymer.

Vinyl esters may be vinyl esters of C₂-C₁₁-alkanoic acids, for example, but not limited to, vinyl acetate, vinyl propionate, vinyl butanoate, vinyl valerate, vinyl hexanoate, vinyl versatate or a mixture thereof.

In the present invention, vinyl acetate is the preferred vinyl ester for the shell polymer.

The styrene and its derivatives may be unsubstituted styrene or C1-C6-alkyl substituted styrenes, for example, but not limited to, styrene, α-methylstyrene, ortho-, meta- and para-methylstyrene, ortho-, meta- and para-ethylstyrene, o,p-dimethylstyrene, o,p-diethylstyrene, ispropylstyrene, o-methyl-p-isopropylstyrene or any mixture thereof.

In the present invention, styrene is the preferred monomer for the core polymer.

The hydrophilic monomers may be selected from monoethylenically unsaturated monomers containing at least one functional group selected from a group consisting of carboxyl, carboxylic anhydride, sulfonic acid, phosphoric acid, hydroxyl and amide.

The at least one more hydrophilic monomer includes, but are not limited to, monoethylenically unsaturated carboxylic acids, such as (meth)acrylic acid, itaconic acid, fumaric acid, citraconic acid, sorbic acid, cinnamic acid, glutaconic acid and maleic acid; monoethylenically unsaturated carboxylic anhydride, such as itaconic acid anhydride, fumaric acid anhydride, citraconic acid anhydride, sorbic acid anhydride, cinnamic acid anhydride, glutaconic acid anhydride and maleic acid anhydride; monoethylenically unsaturated amides, especially N-alkylolamides, such as (meth)acrylamide, N-methylol (meth)acrylamide, 2-hydroxyethyl (meth)acrylamide; and hydroxyalkyl esters of monoethylenically unsaturated carboxylic acids, such as hydroxyethyl (meth)acrylate and hydroxypropyl (meth)acrylate.

In a preferred embodiment according to the present invention, acrylic acid, methacrylic acid, acrylamide or a mixture thereof is preferred as the at least one hydrophilic monomer for the shell polymer.

The hydrophilic monomers can be in an amount of 0.1 to 20 wt %, preferably in an amount of 1 to 20 wt %, more preferably in an amount of 1 to 15 wt % and most preferably in an amount of 5 to 15 wt %, based on the total amount of monomers used for the shell polymer.

Hydrophobic co-monomers may be used to copolymerize with the styrene to synthesize the core polymer or vinyl esters to synthesize the shell polymer. Hydrophobic co-monomers can be chosen from a group consisting of (meth)acrylate monomers, (meth)acrylonitrile monomers, and monoethylenically unsaturated di- and tricarboxylic esters.

Particularly, the (meth)acrylate monomers may be C₁-C₁₉-alkyl (meth)acrylates, for example, but not limited to, methyl (meth)acrylate, ethyl (meth)acrylate, n-butyl (meth)acrylate, 2-ethylhexyl (meth)acrylate, cyclohexyl (meth)acrylate, n-octyl (meth)acrylate, n-decyl (meth)acrylate, n-dodecyl (meth)acrylate (i.e. lauryl (meth)acrylate), tetradecyl (meth)acrylate, oleyl (meth)acrylate, palmityl (meth)acrylate, stearyl (meth)acrylate, isobornyl (meth)acrylate, benzyl (meth)acrylate, phenyl (meth)acrylate and a mixture thereof.

Monoethylenically unsaturated di- and tricarboxylic ester monomers may be full esters of monoethylenically unsaturated di- and tricarboxylic acids, for example, but not limited to, diethyl maleate, dimethyl fumarate, ethyl methyl itaconate, dihexyl succinate, didecyl succinate or any mixture thereof.

In a preferred embodiment according to the present invention, one or more C₁-C₁₂-alkyl (meth)acrylates, such as methyl (meth)acrylate, ethyl (meth)acrylate, n-butyl (meth)acrylate and 2-ethylhexyl (meth)acrylate or a mixture thereof is chosen as the hydrophobic co-monomer for the shell or core polymer.

There can be crosslinking monomers presented in the monomer composition for both the core polymer and the shell polymer, which can be chosen from di- or poly-isocyanates, polyaziridines, polycarbodiimide, polyoxazolines, glyoxals, malonates, triols, epoxy molecules, organic silanes, carbamates, diamines and triamines, hydrazides, carbodiimides and multi-ethylenically unsaturated monomers. In the present invention, suitable crosslinking monomers include, but not limited to, glycidyl (meth)acrylate, N-methylol(meth)acrylamide, (isobutoxymethyl)acrylamide, vinyltrialkoxysilanes such as vinyltrimethoxysilane; alkylvinyldialkoxysilanes such as dimethoxymethylvinylsilane; (meth)acryloxyalkyltrialkoxysilanes such as (meth)acryloxyethyltrimethoxysilane, (3-acryloxypropyl)trimethoxysilane and (3-methacryloxypropyl)trimethoxysilane, allyl methacrylate, diallyl phthalate, 1,4-butylene glycol dimethacrylate, 1,2-ethylene glycol dimethacrylate, 1,6-hexanediol diacrylate, divinyl benzene or any mixture thereof.

The crosslinker can be added in an amount of no more than 10% by weight, preferably no more than 8% by weight, more preferably no more than 5% by weight, based on the total weight of the all monomers used for the synthesis of the respective core and shell polymers.

To control the degree polymerization and therefore the molecular weight of the core-shell polymer, a chain transfer agent can be applied. Suitable chain transfer agents include, but are not limited to, halogen compounds such as tetrabromomethane; alcohols, such as methanol, ethanol and butanol; C₂₋₈-ketones such as acetone, methylethyl ketone, acetaldehyde, n-butyl aldehyde, benzaldehyde; linear or branched alkyl mercaptans, such as methyl mercaptan, cyclohexyl mercaptan and lauryl mercaptan. Other examples of chain transfer agents also include thioglycolic acid, 2-ethylhexyl thioglycolate, mercaptoethanol, octyl thioglycolate, and thioglycerol, mercaptoacetates such as 2-ethylhexyl mercaptoacetate.

The chain transfer agent may be mixed together with monomers or fed into the reactor separately. The one chain transfer agent may be used in any conventional amount, for example, 0.01 to 5 wt %, preferably 0.05 to 2.5 wt %, based on the amount of the all monomer(s) to be polymerized.

In the present invention, it's essential to have a proper weight ratio of the core/shell polymers. The shell polymer is used to encapsulate the core polymer and stabilize the core-shell structure. When the shell ratio is too low, the shell polymer can not have good encapsulation effect and the core-shell polymer also becomes less stable. The weight ratio of the core/shell polymers also has an effect on the core-shell particle size. In an embodiment of the present invention, the core-shell polymer has a core:shell ratio (in weight) of 90:10 to 45:55. In a preferred embodiment, core-shell polymer has a core:shell ratio (in weight) of 85:15 to 55:45. In a more preferred embodiment, core-shell polymer has a core:shell ratio (in weight) of 80:20 to 55:45.

In the present invention, it's also essential to control the weight percentage of vinyl esters in the shell polymer. When the weight percentage of the vinyl esters is too low, the covering performance will be lowered. In an embodiment of the present invention, the weight percentage of vinyl esters in the shell polymer is in the range of 20 wt % to 95 wt %; in a preferred embodiment, the weight percentage of vinyl esters in the shell is in the range of 25 wt % to 90 wt %; in a more preferred embodiment, the weight percentage of vinyl esters in the shell is in the range of 25 wt % to 85 wt %; in a most preferred embodiment, the weight percentage of vinyl esters in the shell is in the range of 30 wt % to 85 wt %. The weight percentage is based on the total weight of the monomers for the shell polymer. The shell polymer may have a glass transition temperature in the range of −30 to +90 deg C., preferably in the range of −20 to +80 deg C., more preferably in the range of −10 to +70 deg C., and most preferably in the range of 0 to +60 deg C.

In the present invention, styrene is the major monomer for the core polymer while other co-monomers which can copolymerize with styrene may also be presented, such as the hydrophobic and hydrophilic monomers listed above. In an embodiment of the present invention, the weight percentage of styrene in the core polymer is in the range of 70 wt % to 100 wt %; in a preferred embodiment, the weight percentage of styrene in the core polymer is in the range of 80 wt % to 100 wt %; in a more preferred embodiment, the weight percentage of styrene in the core polymer is in the range of 90 wt % to 100 wt %; and in a most preferred embodiment, the weight percentage of styrene in the core polymer is in the range of 95 wt % to 100 wt %. The weight percentage is based on the total weight of the monomers for the core polymer. The core polymer may have a glass transition temperature in the range of +60 to +120 deg C., preferably in the range of +70 to +120 deg C., more preferably in the range of +70 to +110 deg C., and most preferably in the range of +80 to +110 deg C.

In the present invention, the average particle size of the core-shell polymer particles is in the range of 100 to 300 nm, preferably in the range of 120 to 250 nm, and more preferably in the range of 140 to 200 nm.

Many multi-stage polymerization techniques well known in the art may be used for preparing the water-borne core-shell emulsion according to the present invention. There is no specific limitation on the technique that is applicable to the present invention. For example, the water-borne core-shell polymer according to the present invention may be prepared by a multi-stage polymerization process including polymerization of the monomers for the shell polymer first and subsequent the monomers for the core polymer.

The emulsion polymerization may be conducted either as a batch operation or in the form of a feed process (i.e. the reaction mixture is fed into the reactor in a staged or gradient procedure). Feed process is a preferred process. In such a process, optionally a small portion of the reaction mixture of the monomers may be introduced as an initial charge and heated to the polymerization temperature which usually will result in polymer seeds. Then the remainder the polymerization mixture of the monomers is supplied to the reactor. After the completion of the feeding, the reaction is further carried out for another 10 to 30 min and, optionally, followed by complete or partial neutralization of the mixture. After the completion of the first polymerization process, polymerization mixture of the second polymer monomers is supplied to the reactor in the same manner as described above. Upon the completion of the feeding, the polymerization is kept for another 30 to 90 min. Afterwards, the reaction mixture may be subject to oxidants, neutralizing agents, etc.

In the multi-stage polymerization process, many surfactants known to the skilled person in the art may be used. Surfactants may be formulated together with the monomers and fed into a reaction reactor. Alternatively, the surfactants may be added into the reaction medium first followed by the feeding of monomers. Surfactants may be used in a suitable amount known to the skilled person in the art, for example, in a total amount of 0.1% to 6% by weight, based on the total weight of the monomers.

Suitable surfactants may include, but not limited to, alkyl, aryl or alkylaryl sulfate salts, sulfonate salts or phosphate salts; alkyl sulfonic acids; sulfosuccinate salts; fatty alcohol ether sulfate salts, alcohol or phenol ethoxylates, allyl polyoxyalkylene ether sulfate salts, allyl alkyl succinate sulfonate salts, allyl ether hydroxyl propanesulfonate salts, and polyoxyethylene styrenated phenyl ether sulfate salts. Many of the commercial available surfactants are applicable to the present invention, which include, but not limited to, Disponil® LDBS, Disponil® SLS, Disponil® FES, Geropon® DES and Calfax® DB.

The emulsion polymerization may be carried out in the presence of various common initiating systems, including but not limited to a thermal or redox initiator. The initiator is usually used in an amount of no more than 10% by weight, preferably 0.02 to 5% by weight, more preferably 0.1 to 1.5 wt %, based on the total weight of the two stage monomers.

Suitable initiators may be used include, but are not limited to, inorganic peroxides, such as hydrogen peroxide, or peroxodisulfates, or organic peroxides, such as tert-butyl, p-menthyl or cumyl hydroperoxide, tert-butyl perpivalate, and dialkyl or diaryl peroxides, such as di-tert-butyl or di-cumyl peroxide. Azo compounds which may be used, include, but not limited to, 2,2″-azobis(isobutyronitrile), 2,2″-azobis(2,4-dimethylvaleronitrile). Among others, sodium persulfate (SPS), potassium persulfate (KPS), ammonium persulfate (APS), 2,2″-azobis(amidinopropyl) dihydrochloride (AIBA, V-50 TM), and 4,4′-azobis(4-cyanovaleric acid) (ACVA, V501) are preferred as the thermal initiator.

A redox initiator usually comprises an oxidizing agent and a reducing agent. Suitable oxidizing agents include the abovementioned peroxides. Suitable reducing agents may be alkali metal sulfites, such as potassium and/or sodium sulfite, or alkali metal hydrogensulfites, such as potassium and/or sodium hydrogensulfite. Preferable redox initiators include an oxidizing agent selected from the group consisting of t-butylhydroperoxide and hydrogen peroxide, and a reducing agent selected from ascorbic acid, sodium formaldehyde sulfoxylate, sodium acetone bisulfite and sodium metabisulfite (sodium disulfite).

The polymerization may be carried out and maintained at a temperature lower than 100° C. throughout the course of the reaction. Preferably, the polymerization is carried out at a temperature between 60° C. and 95° C. Depending on various polymerization conditions, the polymerization may be carried out for several hours, for example 2 to 8 hours.

An organic base and/or inorganic base may be added into the polymerization system as a neutralizer during the polymerization or after the completion of such process. Suitable neutralizers include, but are not limited to, inorganic bases such as ammonia, sodium/potassium hydroxide, sodium/potassium carbonate or a combination. Organic bases such as dimethyl amine, diethyl amine, triethyl amine, monoethanolamine, triethanolamine, or a mixture thereof can also be used as the neutralizer. Among others, sodium hydroxide, ammonia, dimethylaminoethanol, 2-amino-2-methyl-1-propanol or any mixture thereof are preferable as the neutralizer useful for the polymerization process. Upon the addition of a neutralizer, pH of the final polymer shall be in the range of 6.0 to 10.0, preferably in the range of 7.0 to 9.5, more preferably in the range of 7.0 to 9.0.

The aqueous multi-phase copolymer dispersion according to the present invention may have a solid content in the range of 10% to 70% by weight, preferably 20% to 60% by weight, more preferably 30 to 60% by weight, and most preferably 40 to 60% by weight.

The water-borne core-shell polymer according the present invention may be formulated with pigments, dispersants, defoamer, wax, etc to prepare an ink composition.

Many of the pigments that can disperse in water or aqueous solution may be used for the present invention. Suitable pigments include, but not limited to, organic or inorganic pigments, such as, titanium dioxide or other white pigments, carbon black or other black pigments, soluble azoic pigments, insoluble azoic pigments, basic/acidic lake pigments, azo-pigments, phthalocyanine pigments, dye pigments, condensation polycyclic pigments, nitro-pigments and nitroso pigment. Iridescent and metallic pigments, such as aluminum pigments and bronze pigments, can also be used for special optical effects. The pigment is used in a certain amount, i.e. less in the range of 1 wt % to 15 wt %, with respect to the total ink composition.

Examples of the dispersant that can be used include, but are not limited to, water soluble polymers, such as polyvinyl alcohol, methyl cellulose, ethyl cellulose, hydroxyethyl cellulose, carboxymethyl cellulose, polysodium acrylate and polysodium methacrylate; an anionic surfactant, such as sodium dodecylbenzenesulfonate, sodium octadecylsulfate, sodium oleate, sodium laurate and potassium stearate; a cationic surfactant, such as laurylamine acetate, stearylamine acetate and lauryltrimethylammonium chloride; an amphoteric surfactant, such as lauryldimethylamine oxide; a nonionic surfactant, such as polyoxyethylene alkyl ether, polyoxyethylene alkylphenyl ether and polyoxyethylene alkylamine; an inorganic salt, such as tricalcium phosphate, aluminum hydroxide, calcium sulfate, calcium carbonate and barium carbonate; mixtures thereof; and the like. The dispersant is used in a small amount, i.e. less than 5 wt %, with respect to the total ink composition.

Suitable wax includes, but not limited to, natural waxes, modified natural waxes, synthetic waxes and compounded waxes. Natural waxes may be of vegetable, animal, or mineral origin. Modified natural waxes are natural waxes that have been treated chemically to change their nature and properties. Synthetic waxes are made by the reaction or polymerization of chemicals. Compounded waxes are mixtures of various waxes or of waxes with resins or other compounds added thereto. Examples of suitable waxes may include paraffins, olefins such as polyethylene and polypropylene, microcrystalline waxes, ester waxes, fatty acids and other waxy materials, fatty amide containing materials, sulfonamide materials. Wax may be presented in an amount of 1 wt % to 20 wt %, with respect to the total ink composition.

The defoamer is not particularly limited to, and may be appropriately selected according to the purpose. For example, a silicone defoamer, a polyether defoamer, a fatty acid ester defoamer, or the like can be suitably applied. These may be used alone or in combination of two or more.

The water-borne core-shell polymer according the present invention may be formulated into an ink composition by various processes known to the skilled person in the art. There is no particular preference for the preparation of the ink composition. For example, suitable amount of pigments is dispersed in an aqueous medium under high shear speed in a suitable mixer. Then, the water-borne core-shell polymer dispersion is added to the dispersion with continuous feeding. Meanwhile, other necessary materials are also fed into the mixer, which may contain dispersants, defoamer, wax, etc.

The present invention is further demonstrated and exemplified in the Examples, however, without being limited to the embodiments described in the Examples.

### EXAMPLES

Description of commercially available materials used in the following Examples:

Disponil® FES 77, from BASF, Fatty alcohol polyglycol ether sulphate, sodium salt.

Disponil® FES 27, from BASF, Sodium lauryl ether sulphate.

Disponil® SLS 103, from BASF, Sodium lauryl sulfate.

Dissolvine® E-FE-13, from AkzoNobel, EDTA ferric sodium complex.

Golpanol® VS, from BASF, sodium vinyl sulfonate.

Sable® 6500, from Cary Company, black pigment.

Joncryl® HPD 196MEA, from BASF, dispersion resin.

FoamStar® SI 2250, from BASF, defoamer.

Joncryl® Wax 26, from BASF, wax.

All experiments described hereinafter were performed at a temperature of 20 deg C. unless otherwise specified.

The average particle diameter of the copolymer particles as referred herein relates to the Z average particle diameter as determined by means of dynamic light scattering (DLS) method. The measurement method is described in the ISO 13321:1996 standard. For this purpose, a sample of the aqueous copolymer dispersion will be diluted and the obtained aqueous dilution will be analyzed. In the context of DLS, the aqueous dilution may have a polymer concentration in the range from 0.001 to 0.5% by weight, depending on the particle size. For most purposes, a proper concentration will be 0.01% by weight. However, higher or lower concentrations may be used to achieve an optimum signal/noise ratio. The dilution can be achieved by addition of the aqueous copolymer dispersion to water or an aqueous solution of a surfactant in order to avoid flocculation. Usually, the dilution is performed by using a 0.1 wt % aqueous solution of a non-ionic emulsifier, e.g. an ethoxylated C16/C18 alkanol (with ethoxylation degree of 18), as a diluent.

Measurement configuration: High-performance particle sizer (HPPS) from Malvern Instruments, UK, automated, with continuous-flow cuvette and Gilson autosampler.

Parameters: measurement temperature 20.0° C.; measurement time 120 seconds (6 cycles, each of 20 s); scattering angle 173; laser wavelength 633 nm (HeNe); refractive index of medium 1.332 (aqueous); viscosity 0.9546 mPas.

The measurement gives an average value of the second order cumulant analysis (mean of fits), i.e. Z average. The “mean of fits” is an average, intensity-weighted hydrodynamic particle diameter in nm.

The glass transition temperature Tg here is meant the temperature at the inflection point (“midpoint temperature”) determined in accordance with ISO 11357-2:2013 by differential scanning calorimetry (DSC).

### Example 1

To a 4-neckglass reactor equipped with reflux, 390 g DI water, 22.09 g Disponil FES 77 and 2.1 g Dissolvine E-FE-13 were added. Then the reactor mass was heated up to 75 deg C.

A shell monomer mixture was prepared by mixing 36.7 g acrylic acid (AA), 36.7 g butyl acrylate (BA), 20.0 g Golpanol VS (VS), 16.51 g t-dodecyl mercaptan, 16.5 g 2-Ethylhexyl mercaptoacetate and 293.58 g vinyl acetate (Vae).

When inner temperature of reactor reached 75 deg C., 11.6 g sodium persulfate aqueous solution (7 wt %) and 5.8 g sodium bisulfite aqueous solution (7 wt %) were added into reactor as one shot from different neck at the same time, then immediately the above prepared shell monomer mixture was started feeding into reactor with constant flow rate over 1.75 hours. Meanwhile, 69.4 g sodium persulfate aqueous solution (3.5 wt %) and 46.2 g sodium bisulfite aqueous solution (3.5 wt %) were started feeding into reactor from different neck over 2 hours. The inner reactor temperature was maintained at 75 deg C. in all of the abovementioned process. When the shell monomer mixture feed was finished, 80 g of flush water were added through the shell monomer feed glass vessel and pipe in order to clean the residual monomer mixture in the feeding system.

When the above 2 hours sodium persulfate and sodium bisulfite were finished, hold the reactor at 75 deg C. for an extra 10-min. Then 16.2 g t-butyl hydroperoxide aqueous solution (5 wt %) and 23.1 g sodium bisulfite aqueous solution (3.5 wt %) were fed into the reactor from a different neck in 20 mins. After this feed was finished, 43.3 g ammonia aqueous solution (20 wt %) was added as one shot into reactor to neutralize the reaction mixture and after the shot the reaction was kept at 75 deg C. for 5 mins. Then use 15 g flush water to wash the ammonia pipe and add this amount of water into the reactor.

Immediately after above 15 g flush water was added, 607.5 g of styrene was feeding into the reactor constantly over 2 hours. At the same time, 138.8 g sodium persulfate aqueous solution (3.5 wt %) and 104.1 g of sodium bisulfite aqueous solution (3.5 wt %) were started feeding into the reactor in parallel from different necks over 2.5 hours. After styrene feed was finished, use 100 g of flush water to clean the styrene glass vessel and add this washing water into the reactor afterwards.

The resulted core-shell polymer has a Tg of the shell of 11 deg C. and Tg of the core of 88 deg C., and the emulsion has a solid content of 49 wt % and particle size of 179 nm.

### Example 2

To a 4-neckglass reactor equipped with reflux, 360 g DI water, 22.09 g Disponil FES 77, 2.1 g Dissolvine E-FE-13 were added. Then the reactor mass was heated up to 75 deg C.

A shell monomer mixture was prepared by mixing 22.22 g acrylic acid (AA), 37.04 g butyl acrylate (BA), 20.00 g Golpanol VS (VS), 14.81 g t-dodecyl mercaptan, 14.81 g 2-Ethylhexyl mercaptoacetate and 311.11 g vinyl acetate (Vae).

When inner temperature of reactor reached 75 deg C., 11.6 g sodium persulfate aqueous solution (7 wt %) and 5.8 g sodium bisulfite aqueous solution (7 wt %) were added into reactor as one shot from different neck at the same time, then immediately the above prepared shell monomer mixture was started feeding into reactor with constant flow rate over 1.75 hours. Meanwhile, 69.4 g sodium persulfate aqueous solution (3.5 wt %) and 46.3 g sodium bisulfite aqueous solution (3.5 wt %) were started feeding into reactor from different neck over 2 hours. The inner reactor temperature was maintained at 75 deg C. in all of the abovementioned process. When the shell monomer mixture feed was finished, 80 g of flush water were added through the shell monomer feed glass vessel and pipe in order to clean the residual monomer mixture in the feeding system.

When the above 2 hours sodium persulfate and sodium bisulfite were finished, hold the reactor at 75 deg C. for an extra 10-min. Then 16.2 g t-butyl hydroperoxide aqueous solution (5 wt %) and 23.1 g sodium bisulfite aqueous solution (3.5 wt %) were fed into the reactor from a different neck in 20 mins. After this feed was finished, 26.2 g ammonia aqueous solution (20 wt %) was added as one shot into reactor to neutralize the reaction mixture and after the shot the reaction was kept at 75 deg C. for 5 mins. Then use 15 g flush water to wash the ammonia pipe and add this amount of water into the reactor.

Immediately after above 15 g flush water was added, 607.5 g of styrene was feeding into the reactor constantly over 2 hours. At the same time, 138.8 g sodium persulfate aqueous solution (3.5 wt %) and 104.1 g of sodium bisulfite aqueous solution (3.5 wt %) were started feeding into the reactor in parallel from different necks over 2.5 hours. After styrene feed was finished, use 100 g of flush water to clean the styrene glass vessel and add this washing water into the reactor afterwards.

The resulted core-shell polymer has a Tg of the shell of 8 deg C. and Tg of the core of 89 deg C., and the emulsion has a solid content of 49.1 wt % and particle size of 143 nm.

### Example 3

To a 4-neckglass reactor equipped with reflux, 360 g DI water, 22.09 g Disponil FES 77, 2.1 g Dissolvine E-FE-13 were added. Then the reactor mass was heated up to 75 deg C.

A shell monomer mixture was prepared by mixing 46.15 g acrylic acid (AA), 46.15 g butyl acrylate (BA), 20.0 g Golpanol VS (VS), 7.69 g t-dodecyl mercaptan, 7.69 g 2-Ethylhexyl mercaptoacetate and 292.31 g vinyl acetate (Vae).

When inner temperature of reactor reached 75 deg C., 11.6 g sodium persulfate aqueous solution (7 wt %) and 5.8 g sodium bisulfite aqueous solution (7 wt %) were added into reactor as one shot from different neck at the same time, then immediately the above prepared shell monomer mixture was started feeding into reactor with constant flow rate over 1.5 hours. Meanwhile, 69.4 g sodium persulfate aqueous solution (3.5 wt %) and 46.3 g sodium bisulfite aqueous solution (3.5 wt %) were started feeding into reactor from different neck over 1.75 hours. The inner reactor temperature was maintained at 75 deg C. in all of the abovementioned process.

When the shell monomer mixture feed was finished, 80 g of flush water were added through the shell monomer feed glass vessel and pipe in order to clean the residual monomer mixture in the feeding system.

When the above 1.75 hours sodium persulfate and sodium bisulfite were finished, hold the reactor at 75 deg C. for an extra 10-min. Then 16.2 g t-butyl hydroperoxide aqueous solution (5 wt %) and 23.1 g sodium bisulfite aqueous solution (3.5 wt %) were fed into the reactor from a different neck in 20 mins. After this feed was finished, 54.5 g ammonia aqueous solution (20 wt %) was added as one shot into reactor to neutralize the reaction mixture and after the shot the reaction was kept at 75 deg C. for 5 mins. Then use 15 g flush water to wash the ammonia pipe and add this amount of water into the reactor.

Immediately after above 15 g flush water was added, 822.27 g of styrene was feeding into the reactor constantly over 2.25 hours. At the same time, 187.9 g sodium persulfate aqueous solution (3.5 wt %) and 141.0 g of sodium bisulfite aqueous solution (3.5 wt %) were started feeding into the reactor in parallel from different necks over 2.5 hours. After styrene feed was finished, use 120 g of flush water to clean the styrene glass vessel and add this washing water into the reactor afterwards.

The resulted core-shell polymer has a Tg of the shell of 26 deg C. and Tg of the core of 98 deg C., and the emulsion has a solid content 50.5 wt % and particle size of 257 nm.

### Example 4

To a 4-neckglass reactor equipped with reflux, 390 g DI water, 22.09 g Disponil FES 27, 2.1 g Dissolvine E-FE-13 were added. Then the reactor mass was heated up to 75 deg C.

A shell monomer mixture was prepared by mixing 39.02 g acrylic acid (AA), 39.02 g butyl acrylate (BA), 20.0 g Golpanol VS (VS), 7.32 g t-dodecyl mercaptan, 2.44 g 2-Ethylhexyl mercaptoacetate and 312.2 g vinyl acetate (Vae).

When inner temperature of reactor reached 75 deg C., 11.6 g sodium persulfate aqueous solution (7 wt %) and 5.8 g sodium bisulfite aqueous solution (7 wt %) were added into reactor as one shot from different neck at the same time, then immediately the above prepared shell monomer mixture was started feeding into reactor with constant flow rate over 1.5 hours. Meanwhile, 69.4 g sodium persulfate aqueous solution (3.5 wt %) and 46.3 g sodium bisulfite aqueous solution (3.5 wt %) were started feeding into reactor from different neck over 1.75 hours. The inner reactor temperature was maintained at 75 deg C. in all of the abovementioned process. When the shell monomer mixture feed was finished, 170 g of flush water were added through the shell monomer feed glass vessel and pipe in order to clean the residual monomer mixture in the feeding system.

When the above 1.75 hours sodium persulfate and sodium bisulfite were finished, hold the reactor at 75 deg C. for an extra 10-min. Then 16.2 g t-butyl hydroperoxide aqueous solution (5 wt %) and 23.1 g sodium bisulfite aqueous solution (3.5 wt %) were fed into the reactor from a different neck in 20 mins. After this feed was finished, 46.1 g ammonia aqueous solution (20 wt %) was added as one shot into reactor to neutralize the reaction mixture and after the shot the reaction was kept at 75 deg C. for 5 mins. Then use 15 g flush water to wash the ammonia pipe and add this amount of water into the reactor.

Immediately after above 15 g flush water was added, 945.0 g of styrene was feeding into the reactor constantly over 2.25 hours. At the same time, 216.0 g sodium persulfate aqueous solution (3.5 wt %) and 162.0 g of sodium bisulfite aqueous solution (3.5 wt %) were started feeding into the reactor in parallel from different necks over 2.5 hours. After styrene feed was finished, use 170 g of flush water to clean the styrene glass vessel and add this washing water into the reactor afterwards.

The resulted core-shell polymer has a Tg of the shell of 40 deg C. and Tg of the core of 103 deg C., and the emulsion has a solid content of 50.2 wt % and particle size of 242 nm.

### Example 5

To a 4-neckglass reactor equipped with reflux, 390 g DI water, 22.09 g Disponil FES 77, 2.1 g Dissolvine E-FE-13 were added. Then the reactor mass was heated up to 75 deg C.

A shell monomer mixture was prepared by mixing 46.6 g acrylic acid (AA), 46.6 g butyl acrylate (BA), 20.0 g Golpanol VS (VS), 11.65 g 2-Ethylhexyl mercaptopropanoate and 295.15 g vinyl acetate (Vae).

When inner temperature of reactor reached 75 deg C., 11.6 g sodium persulfate aqueous solution (7 wt %) and 5.8 g sodium bisulfite aqueous solution (7 wt %) were added into reactor as one shot from different neck at the same time, then immediately the above prepared shell monomer mixture was started feeding into reactor with constant flow rate over 1.5 hours. Meanwhile, 69.4 g sodium persulfate aqueous solution (3.5 wt %) and 46.3 g sodium bisulfite aqueous solution (3.5 wt %) were started feeding into reactor from different neck over 1.75 hours. The inner reactor temperature was maintained at 75 deg C. in all of the abovementioned process. When the shell monomer mixture feed was finished, 150 g of flush water were added through the shell monomer feed glass vessel and pipe in order to clean the residual monomer mixture in the feeding system.

When the above 1.75 hours sodium persulfate and sodium bisulfite were finished, hold the reactor at 75 deg C. for an extra 10-min. Then 16.2 g t-butyl hydroperoxide aqueous solution (5 wt %) and 23.1 g sodium bisulfite aqueous solution (3.5 wt %) were fed into the reactor from a different neck in 20 mins. After this feed was finished, 46.1 g ammonia aqueous solution (20 wt %) was added as one shot into reactor to neutralize the reaction mixture and after the shot the reaction was kept at 75 deg C. for 5 mins. Then use 15 g flush water to wash the ammonia pipe and add this amount of water into the reactor.

Immediately after above 15 g flush water was added, 822.27 g of styrene was feeding into the reactor constantly over 2.25 hours. At the same time, 187.9 g sodium persulfate aqueous solution (3.5 wt %) and 141.6 g of sodium bisulfite aqueous solution (3.5 wt %) were started feeding into the reactor in parallel from different necks over 2.5 hours. After styrene feed was finished, use 170 g of flush water to clean the styrene glass vessel and add this washing water into the reactor afterwards.

The resulted core-shell polymer has a Tg of the shell of 38 deg C. and Tg of the core of 101 deg C., and the emulsion has a solid content 49 wt % and particle size of 195 nm.

### Example 6

To a 4-neckglass reactor equipped with reflux, 390 g DI water, 16.02 g Disponil FES 77, 2.1 g Dissolvine E-FE-13 were added. Then the reactor mass was heated up to 75 deg C.

A shell monomer mixture was prepared by mixing 33.14 g acrylic acid (AA), 27.62 g butyl acrylate (BA), 14.5 g Golpanol VS (VS), 6.91 g t-dodecyl mercaptan, 6.91 g 2-ethylhexyl mercaptopropanoate and 215.43 g vinyl acetate (Vae).

When inner temperature of reactor reached 75 deg C., 8.4 g sodium persulfate aqueous solution (7 wt %) and 4.2 g sodium bisulfite aqueous solution (7 wt %) were added into reactor as one shot from different neck at the same time, then immediately the above prepared shell monomer mixture was started feeding into reactor with constant flow rate over 1.25 hours. Meanwhile, 50.3 g sodium persulfate aqueous solution (3.5 wt %) and 33.6 g sodium bisulfite aqueous solution (3.5 wt %) were started feeding into reactor from different neck over 1.5 hours. The inner reactor temperature was maintained at 75 deg C. in all of the abovementioned process. When the shell monomer mixture feed was finished, 100 g of flush water were added through the shell monomer feed glass vessel and pipe in order to clean the residual monomer mixture in the feeding system.

When the above 1.5 hours sodium persulfate and sodium bisulfite were finished, hold the reactor at 75 deg C. for an extra 10-min. Then 11.7 g t-butyl hydroperoxide aqueous solution (5 wt %) and 16.8 g sodium bisulfite aqueous solution (3.5 wt %) were fed into the reactor from a different neck in 20 mins. After this feed was finished, 39.1 g ammonia aqueous solution (20 wt %) was added as one shot into reactor to neutralize the reaction mixture and after the shot the reaction was kept at 75 deg C. for 5 mins. Then use 15 g flush water to wash the ammonia pipe and add this amount of water into the reactor.

Immediately after above 15 g flush water was added, 685.13 g of styrene was feeding into the reactor constantly over 1 hour and 55 mins. At the same time, 156.6 g sodium persulfate aqueous solution (3.5 wt %) and 117.5 g of sodium bisulfite aqueous solution (3.5 wt %) were started feeding into the reactor in parallel from different necks over 2 hours and 10 mins. After styrene feed was finished, use 130 g of flush water to clean the styrene glass vessel and add this washing water into the reactor afterwards.

The resulted core-shell polymer has a Tg of the shell of 30 deg C. and Tg of the core of 99 deg C., and the emulsion has a solid content of 49 wt % and particle size of 155 nm.

### Example 7

To a 4-neckglass reactor equipped with reflux, 480 g DI water, 13.81 g Disponil FES 77, 2.1 g Dissolvine E-FE-13 were added. Then the reactor mass was heated up to 75 deg C.

A shell monomer mixture was prepared by mixing 41.67 g acrylic acid (AA), 50.93 g butyl acrylate (BA), 12.5 g Golpanol VS (VS), 18.52 g t-dodecyl mercaptan, and 138.89 g vinyl acetate (Vae).

When inner temperature of reactor reached 75 deg C., 7.2 g sodium persulfate aqueous solution (7 wt %) and 3.6 g sodium bisulfite aqueous solution (7 wt %) were added into reactor as one shot from different neck at the same time, then immediately the above prepared shell monomer mixture was started feeding into reactor with constant flow rate over 1.25 hours. Meanwhile, 43.4 g sodium persulfate aqueous solution (3.5 wt %) and 28.9 g sodium bisulfite aqueous solution (3.5 wt %) were started feeding into reactor from different neck over 1.5 hours. The inner reactor temperature was maintained at 75 deg C. in all of the abovementioned process. When the shell monomer mixture feed was finished, 75 g of flush water were added through the shell monomer feed glass vessel and pipe in order to clean the residual monomer mixture in the feeding system.

When the above 1.5 hours sodium persulfate and sodium bisulfite were finished, hold the reactor at 75 deg C. for an extra 10-min. Then 10.1 g t-butyl hydroperoxide aqueous solution (5 wt %) and 14.5 g sodium bisulfite aqueous solution (3.5 wt %) were fed into the reactor from a different neck in 20 mins. After this feed was finished, 41.3 g ammonia aqueous solution (20 wt %) was added as one shot into reactor to neutralize the reaction mixture and after the shot the reaction was kept at 75 deg C. for 5 mins. Then use 15 g flush water to wash the ammonia pipe and add this amount of water into the reactor.

Immediately after above 15 g flush water was added, 162.5 g of vinyl acetate (Vae) and 50.0 g of ethyl acrylate (EA) were fed into the reactor over 40 mins. And, after the feeding, 75 g flush water was used to clean the vessel. After the cleaning, 850.0 g of styrene was feeding into the reactor constantly over 2 hours. At the same time of Vae and EA feeding, 242.9 g sodium persulfate aqueous solution (3.5 wt %) and 182.1 g of sodium bisulfite aqueous solution (3.5 wt %) were started feeding into the reactor in parallel from different necks over 3 hours. After styrene feed was finished, use 130 g of flush water to clean the styrene glass vessel and add this washing water into the reactor afterwards.

The resulted core-shell polymer has a Tg of the shell of 18 deg C. and Tg of the core of 99 deg C., and the emulsion has a solid content of 48.5 wt % and particle size of 143 nm.

### Example 8

To a 4-neckglass reactor equipped with reflux, 430 g DI water, 13.25 g Disponil FES 77, 2.1 g Dissolvine E-FE-13 were added. Then the reactor mass was heated up to 75 deg C.

A shell monomer mixture was prepared by mixing 36.92 g acrylic acid (AA), 27.62 g ethyl acrylate (EA), 4.62 g butyl acrylate (BA), 12.0 g Golpanol VS (VS), 9.23 g t-dodecyl mercaptan, and 161.54 g vinyl acetate (Vae).

When inner temperature of reactor reached 75 deg C., 6.9 g sodium persulfate aqueous solution (7 wt %) and 3.5 g sodium bisulfite aqueous solution (7 wt %) were added into reactor as one shot from different neck at the same time, then immediately the above prepared shell monomer mixture was started feeding into reactor with constant flow rate over 1.25 hours. Meanwhile, 41.7 g sodium persulfate aqueous solution (3.5 wt %) and 27.8 g sodium bisulfite aqueous solution (3.5 wt %) were started feeding into reactor from different neck over 1.5 hours. The inner reactor temperature was maintained at 75 deg C. in all of the abovementioned process. When the shell monomer mixture feed was finished, 75 g of flush water were added through the shell monomer feed glass vessel and pipe in order to clean the residual monomer mixture in the feeding system.

When the above 1.5 hours sodium persulfate and sodium bisulfite were finished, hold the reactor at 75 deg C. for an extra 10-min. Then 9.7 g t-butyl hydroperoxide aqueous solution (5 wt %) and 13.9 g sodium bisulfite aqueous solution (3.5 wt %) were fed into the reactor from a different neck in 20 mins. After this feed was finished, 26.5 g ammonia aqueous solution (20 wt %) was added as one shot into reactor to neutralize the reaction mixture and after the shot the reaction was kept at 75 deg C. for 5 mins. Then use 15 g flush water to wash the ammonia pipe and add this amount of water into the reactor.

Immediately after above 15 g flush water was added, 813.52 g of styrene was feeding into the reactor constantly over 2 hours. At the same time, 185.9 g sodium persulfate aqueous solution (3.5 wt %) and 139.5 g of sodium bisulfite aqueous solution (3.5 wt %) were started feeding into the reactor in parallel from different necks over 2 hours and 20 mins. After styrene feed was finished, use 105 g of flush water to clean the styrene glass vessel and add this washing water into the reactor afterwards. When the above reaction was finished, hold the reactor mass for additional 15 mins, then an extra 21.8 g ammonia aqueous solution (20 wt %) was added into the reactor to complete the reaction.

The resulted core-shell polymer has a Tg of the shell of 39 deg C. and Tg of the core of 101 deg C., and the emulsion has a solid content of 48.8 wt % and particle size of 140 nm.

### Example 9

To a 4-neckglass reactor equipped with reflux, 400 g DI water, 22.9 g Disponil FES 77, 2.1 g Dissolvine E-FE-13 were added. Then the reactor mass was heated up to 75 deg C.

A shell monomer mixture was prepared by mixing 38.46 g acrylic acid (AA), 38.46 g ethyl acrylate (EA), 20.0 g Golpanol VS (VS), 15.38 g t-dodecyl mercaptan, 51.28 g acrylamide (Am) and 307.69 g vinyl acetate (Vae).

When inner temperature of reactor reached 75 deg C., 12.0 g sodium persulfate aqueous solution (7 wt %) and 6.0 g sodium bisulfite aqueous solution (7 wt %) were added into reactor as one shot from different neck at the same time, then immediately the above prepared shell monomer mixture was started feeding into reactor with constant flow rate over 1.25 hours. Meanwhile, 72.1 g sodium persulfate aqueous solution (3.5 wt %) and 48.0 g sodium bisulfite aqueous solution (3.5 wt %) were started feeding into reactor from different neck over 1.5 hours. The inner reactor temperature was maintained at 75 deg C. in all of the abovementioned process. When the shell monomer mixture feed was finished, 120 g of flush water were added through the shell monomer feed glass vessel and pipe in order to clean the residual monomer mixture in the feeding system.

When the above 1.5 hours sodium persulfate and sodium bisulfite were finished, hold the reactor at 75 deg C. for an extra 10-min. Then 16.8 g t-butyl hydroperoxide aqueous solution (5 wt %) and 24.0 g sodium bisulfite aqueous solution (3.5 wt %) were fed into the reactor from a different neck in 20 mins. After this feed was finished, 22.7 g ammonia aqueous solution (20 wt %) was added as one shot into reactor to neutralize the reaction mixture and after the shot the reaction was kept at 75 deg C. for 5 mins. Then use 15 g flush water to wash the ammonia pipe and add this amount of water into the reactor.

Immediately after above 15 g flush water was added, 853.51 g of styrene was feeding into the reactor constantly over 2 hours and 40 mins. At the same time, 195.1 g sodium persulfate aqueous solution (3.5 wt %) and 146.3 g of sodium bisulfite aqueous solution (3.5 wt %) were started feeding into the reactor in parallel from different necks over 3 hours. After styrene feed was finished, use 140 g of flush water to clean the styrene glass vessel and add this washing water into the reactor afterwards. When the above reaction was finished, hold the reactor mass for additional 15 mins, then an extra 36.3 g ammonia aqueous solution (20 wt %) was added into the reactor to complete the reaction.

The resulted core-shell polymer has a Tg of the shell of 32 deg C. and Tg of the core of 97 deg C., and the emulsion has a solid content of 49.4 wt % and particle size of 167 nm.

### Example 10

To a 4-neckglass reactor equipped with reflux, 390 g DI water, 13.81 g Disponil FES 77, 2.1 g Dissolvine E-FE-13 were added. Then the reactor mass was heated up to 75 deg C.

A shell monomer mixture was prepared by mixing 16.81 g acrylic acid (AA), 108.07 g methyl acrylate (MA), 14.41 g butyl acrylate (BA), 12.5 g Golpanol VS (VS), 9.85 g 2-ethylhexyl mercaptopropanoate and 100.86 g vinyl acetate (Vae).

When inner temperature of reactor reached 75 deg C., 7.2 g sodium persulfate aqueous solution (7 wt %) and 3.6 g sodium bisulfite aqueous solution (7 wt %) were added into reactor as one shot from different neck at the same time, then immediately the above prepared shell monomer mixture was started feeding into reactor with constant flow rate over 1.25 hours. Meanwhile, 43.4 g sodium persulfate aqueous solution (3.5 wt %) and 28.9 g sodium bisulfite aqueous solution (3.5 wt %) were started feeding into reactor from different neck over 1.5 hours. The inner reactor temperature was maintained at 75 deg C. in all of the abovementioned process. When the shell monomer mixture feed was finished, 120 g of flush water were added through the shell monomer feed glass vessel and pipe in order to clean the residual monomer mixture in the feeding system.

When the above 1.5 hours sodium persulfate and sodium bisulfite were finished, hold the reactor at 75 deg C. for an extra 10-min. Then 10.1 g t-butyl hydroperoxide aqueous solution (5 wt %) and 14.5 g sodium bisulfite aqueous solution (3.5 wt %) were fed into the reactor from a different neck in 20 mins. After this feed was finished, 19.9 g ammonia aqueous solution (20 wt %) was added as one shot into reactor to neutralize the reaction mixture and after the shot the reaction was kept at 75 deg C. for 5 mins. Then use 15 g flush water to wash the ammonia pipe and add this amount of water into the reactor.

Immediately after above 15 g flush water was added, 897.44 g of styrene was feeding into the reactor constantly over 2 hours and 40 mins. At the same time, 175.8 g sodium persulfate aqueous solution (3.5 wt %) and 131.9 g of sodium bisulfite aqueous solution (3.5 wt %) were started feeding into the reactor in parallel from different necks over 2 hours and 40 mins. After styrene feed was finished, use 100 g of flush water to clean the styrene glass vessel and add this washing water into the reactor afterwards. Then start feeding 35.9 g t-butyl hydroperoxide aqueous solution (5 wt %) and 51.3 g sodium bisulfite aqueous solution (3.5 wt %) were fed into the reactor from a different neck in 20 mins. When the above reaction was finished, hold the reactor mass for additional 15 mins, then an extra 7.9 g ammonia aqueous solution (20 wt %) was added into the reactor to complete the reaction.

The resulted core-shell polymer has a Tg of the shell of 25 deg C. and Tg of the core of 104 deg C., and the emulsion has a solid content of 49.7 wt % and particle size of 163 nm.

### Example 11

To a 4-neckglass reactor equipped with reflux, 350 g DI water, 16.557 g Disponil FES 77, 2.1 g Dissolvine E-FE-13 were added. Then the reactor mass was heated up to 75 deg C.

A shell monomer mixture was prepared by mixing 28.71 g acrylic acid (AA), 43.06 g methyl methacrylate (MMA), 215.31 g methyl acrylate (MA), 15.0 g Golpanol VS (VS) and 12.92 g t-dodecyl mercaptan.

When inner temperature of reactor reached 75 deg C., 8.7 g sodium persulfate aqueous solution (7 wt %) and 4.3 g sodium bisulfite aqueous solution (7 wt %) were added into reactor as one shot from different neck at the same time, then immediately the above prepared shell monomer mixture was started feeding into reactor with constant flow rate over 1.5 hours. Meanwhile, 52.1 g sodium persulfate aqueous solution (3.5 wt %) and 34.7 g sodium bisulfite aqueous solution (3.5 wt %) were started feeding into reactor from different neck over 1.5 hours. The inner reactor temperature was maintained at 75 deg C. in all of the abovementioned process. When the shell monomer mixture feed was finished, 120 g of flush water were added through the shell monomer feed glass vessel and pipe in order to clean the residual monomer mixture in the feeding system.

When the above 1.5 hours sodium persulfate and sodium bisulfite were finished, hold the reactor at 75 deg C. for an extra 10-min. Then 12.2 g t-butyl hydroperoxide aqueous solution (5 wt %) and 17.4 g sodium bisulfite aqueous solution (3.5 wt %) were fed into the reactor from a different neck in 20 mins. After this feed was finished, 37.3 g ammonia aqueous solution (20 wt %) was added as one shot into reactor to neutralize the reaction mixture and after the shot the reaction was kept at 75 deg C. for 5 mins. Then use 15 g flush water to wash the ammonia pipe and add this amount of water into the reactor.

Immediately after above 15 g flush water was added, 781.07 g of styrene was feeding into the reactor constantly over 2 hours and 40 mins. At the same time, 153.0 g sodium persulfate aqueous solution (3.5 wt %) and 114.8 g of sodium bisulfite aqueous solution (3.5 wt %) were started feeding into the reactor in parallel from different necks over 2 hours and 40 mins. After styrene feed was finished, use 100 g of flush water to clean the styrene glass vessel and add this washing water into the reactor afterwards. Then start feeding 31.2 g t-butyl hydroperoxide aqueous solution (5 wt %) and 44.6 g sodium bisulfite aqueous solution (3.5 wt %) were fed into the reactor from a different neck in 20 mins. When the above reaction was finished, hold the reactor mass for additional 15 mins, then an extra 8.5 g ammonia aqueous solution (20 wt %) was added into the reactor to complete the reaction.

The resulted core-shell polymer has a Tg of the shell of 29 deg C. and Tg of the core of 101 deg C., and the emulsion has a solid content of 49.6 wt % and particle size of 111 nm.

### Example 12

To a 4-neckglass reactor equipped with reflux, 360 g DI water, 13.6 g Disponil FES 77, 2.1 g Dissolvine E-FE-13 were added. Then the reactor mass was heated up to 75 deg C.

A shell monomer mixture was prepared by mixing 23.96 g acrylic acid (AA), 47.92 g methyl methacrylate (MMA), 143.75 g methyl acrylate (MA), 23.96 g butyl acrylate (BA), 10.42 g t-dodecyl mercaptan.

When inner temperature of reactor reached 75 deg C., 7.1 g sodium persulfate aqueous solution (7 wt %) and 3.6 g sodium bisulfite aqueous solution (7 wt %) were added into reactor as one shot from different neck at the same time, then immediately the above prepared shell monomer mixture was started feeding into reactor with constant flow rate over 1.5 hours. Meanwhile, 42.9 g sodium persulfate aqueous solution (3.5 wt %) and 28.6 g sodium bisulfite aqueous solution (3.5 wt %) were started feeding into reactor from different neck over 1.5 hours. The inner reactor temperature was maintained at 75 deg C. in all of the abovementioned process. When the shell monomer mixture feed was finished, 120 g of flush water were added through the shell monomer feed glass vessel and pipe in order to clean the residual monomer mixture in the feeding system.

When the above 1.5 hours sodium persulfate and sodium bisulfite were finished, hold the reactor at 75 deg C. for an extra 10-min. Then 10.0 g t-butyl hydroperoxide aqueous solution (5 wt %) and 14.3 g sodium bisulfite aqueous solution (3.5 wt %) were fed into the reactor from a different neck in 20 mins. After this feed was finished, 29.7 g ammonia aqueous solution (20 wt %) was added as one shot into reactor to neutralize the reaction mixture and after the shot the reaction was kept at 75 deg C. for 5 mins. Then use 15 g flush water to wash the ammonia pipe and add this amount of water into the reactor.

Immediately after above 15 g flush water was added, 791.67 g of styrene was feeding into the reactor constantly over 2 hours and 40 mins. At the same time, 155.1 g sodium persulfate aqueous solution (3.5 wt %) and 116.3 g of sodium bisulfite aqueous solution (3.5 wt %) were started feeding into the reactor in parallel from different necks over 2 hours and 40 mins. After styrene feed was finished, use 100 g of flush water to clean the styrene glass vessel and add this washing water into the reactor afterwards. Then start feeding 31.7 g t-butyl hydroperoxide aqueous solution (5 wt %) and 45.2 g sodium bisulfite aqueous solution (3.5 wt %) were fed into the reactor from a different neck in 20 mins. When the above reaction was finished, hold the reactor mass for additional 15 mins, then an extra 2.8 g ammonia aqueous solution (20 wt %) was added into the reactor to complete the reaction.

The resulted core-shell polymer has a Tg of the shell of 24 deg C. and Tg of the core of 98 deg C., and the emulsion has a solid content 49.7 wt % and particle size of 121 nm.

### Example 13

To a 4-neckglass reactor equipped with reflux, 370 g DI water, 6.82 g Disponil FES 27, 6.82 g Disponil SLS 103, 2.1 g Dissolvine E-FE-13 were added. Then the reactor mass was heated up to 75 deg C.

A shell monomer mixture was prepared by mixing 23.97 g acrylic acid (AA), 35.95 g methyl methacrylate (MMA), 143.82 g methyl acrylate (MA), 35.95 g butyl acrylate (BA), 10.31 g t-dodecyl mercaptan.

When inner temperature of reactor reached 75 deg C., 7.1 g sodium persulfate aqueous solution (7 wt %) and 3.6 g sodium bisulfite aqueous solution (7 wt %) were added into reactor as one shot from different neck at the same time, then immediately the above prepared shell monomer mixture was started feeding into reactor with constant flow rate over 1.5 hours. Meanwhile, 57.1 g sodium persulfate aqueous solution (3.5 wt %) and 42.9 g sodium bisulfite aqueous solution (3.5 wt %) were started feeding into reactor from different neck over 1.5 hours. The inner reactor temperature was maintained at 75 deg C. in all of the abovementioned process. When the shell monomer mixture feed was finished, 120 g of flush water were added through the shell monomer feed glass vessel and pipe in order to clean the residual monomer mixture in the feeding system.

When the above 1.5 hours sodium persulfate and sodium bisulfite were finished, hold the reactor at 75 deg C. for an extra 10-min. Then, 21.2 g ammonia aqueous solution (20 wt %) was added as one shot into reactor to neutralize the reaction mixture and after the shot the reaction was kept at 75 deg C. for 5 mins. Then use 15 g flush water to wash the ammonia pipe and add this amount of water into the reactor.

Immediately after above 15 g flush water was added, 791.67 g of styrene was feeding into the reactor constantly over 2 hours and 40 mins. At the same time, 155.1 g sodium persulfate aqueous solution (3.5 wt %) and 116.3 g of sodium bisulfite aqueous solution (3.5 wt %) were started feeding into the reactor in parallel from different necks over 2 hours and 40 mins. After styrene feed was finished, use 100 g of flush water to clean the styrene glass vessel and add this washing water into the reactor afterwards. Then start feeding 31.7 g t-butyl hydroperoxide aqueous solution (5 wt %) and 45.2 g sodium bisulfite aqueous solution (3.5 wt %) were fed into the reactor from a different neck in 20 mins. When the above reaction was finished, hold the reactor mass for additional 15 mins, then an extra 9.9 g ammonia aqueous solution (20 wt %) was added into the reactor to complete the reaction.

The resulted core-shell polymer has a Tg of the shell of 20 deg C. and Tg of the core of 100 deg C., and the emulsion has a solid content of 49.7 wt % and particle size of 122 nm.

### Example 14

To a 4-neckglass reactor equipped with reflux, 370 g DI water, 13.98 g Disponil FES 77, 2.1 g Dissolvine E-FE-13 were added. Then the reactor mass was heated up to 75 deg C.

A shell monomer mixture was prepared by mixing 23.99 g acrylic acid (AA), 143.95 g methyl acrylate (MA), 47.98 g methyl methacrylate (MMA), 23.99 g butyl acrylate (BA), 25 g Golpanol VS (VS), 10.08 g t-dodecyl mercaptan.

When inner temperature of reactor reached 70 deg C., 7.32 g sodium persulfate aqueous solution (7 wt %) and 3.66 g sodium bisulfite aqueous solution (7 wt %) were added into reactor as one shot from different neck at the same time, then immediately the above prepared shell monomer mixture was started feeding into reactor with constant flow rate over 1.5 hours. Meanwhile, 58.58 g sodium persulfate aqueous solution (3.5 wt %) and 43.92 g sodium bisulfite aqueous solution (3.5 wt %) were started feeding into reactor from different neck over 1.75 hours. The inner reactor temperature was maintained at 75 deg C. in all of the abovementioned process. When the shell monomer mixture feed was finished, 120 g of flush water were added through the shell monomer feed glass vessel and pipe in order to clean the residual monomer mixture in the feeding system.

When the above 1.75 hours sodium persulfate and sodium bisulfite were finished, hold the reactor at 70 deg C. for an extra 10-min. Then, the temperature was increased to 75 deg C. and 25.49 g ammonia aqueous solution (20 wt %) was added as one shot into reactor to neutralize the reaction mixture and after the shot the reaction was kept at 75 deg C. for 5 mins. Then use 15 g flush water to wash the ammonia pipe and add this amount of water into the reactor.

Immediately after above 15 g flush water was added, 811.46 g of styrene was feeding into the reactor constantly over 2 hours and 40 mins. At the same time, 158.98 g sodium persulfate aqueous solution (3.5 wt %) and 119.24 g of sodium bisulfite aqueous solution (3.5 wt %) were started feeding into the reactor in parallel from different necks over 2 hours and 40 mins. After styrene feed was finished, use 100 g of flush water to clean the styrene glass vessel and add this washing water into the reactor afterwards. Then start feeding 32.46 g t-butyl hydroperoxide aqueous solution (5 wt %) and 46.36 g sodium bisulfite aqueous solution (3.5 wt %) were fed into the reactor from a different neck in 20 mins. When the above reaction was finished, hold the reactor mass for additional 15 mins, then an extra 8.5 g ammonia aqueous solution (20 wt %) was added into the reactor to complete the reaction.

The resulted core-shell polymer has a Tg of the shell of 25 deg C. and Tg of the core of 98 deg C., and the emulsion has a solid content 49.6 wt % and particle size of 175 nm.

Test Methods, Ink Preparation and Performance Test

Tg is determined by Differential Scanning calorimetry (TA DSC Q100, Waters TA, −80 to 120 deg C., “midpoint temperature” of second heating curve, heating rate 10° C./min). The average particle diameter of the copolymer particles as referred herein relates to the Z average particle diameter as determined by means of dynamic light scattering (DLS) method. The measurement method is described in the ISO 13321:1996 standard. For this purpose, a sample of the aqueous copolymer dispersion will be diluted and the obtained aqueous dilution will be analyzed. In the context of DLS, the aqueous dilution may have a polymer concentration in the range from 0.001 to 0.5% by weight, depending on the particle size. For most purposes, a proper concentration will be 0.01% by weight. However, higher or lower concentrations may be used to achieve an optimum signal/noise ratio. The dilution can be achieved by addition of the aqueous copolymer dispersion to water or an aqueous solution of a surfactant in order to avoid flocculation. Usually, the dilution is performed by using a 0.1 wt % aqueous solution of a non-ionic emulsifier, e.g. an ethoxylated C16/C18 alkanol (with ethoxylation degree of 18), as a diluent.

Measurement configuration: High-performance particle sizer (HPPS) from Malvern Instruments, UK, automated, with continuous-flow cuvette and Gilson autosampler.

Parameters: measurement temperature 20.0° C.; measurement time 120 seconds (6 cycles, each of 20 s); scattering angle 173; laser wavelength 633 nm (HeNe); refractive index of medium 1.332 (aqueous); viscosity 0.9546 mPa·s.

The measurement gives an average value of the second order cumulant analysis (mean of fits), i.e. Z average. The “mean of fits” is an average, intensity-weighted hydrodynamic particle diameter in nm.

Covering Property Rating (CPR)

To prepare a film of the emulsion:
1) Use a 12 μm-barcoater to apply an emulsion prepared in the proceeding examples and comparative examples (with a solid content of 48 wt %) onto a corrugated paper substrate;
2) Put the paper substrate in an oven for 1 minute at 50 deg C. to get it dried;

Covering property was rated by visual evaluation according to the following rating criteria. Each test result was evaluated independently by two different technical experts and an average was taken as the rating score.

TABLE 1

| CPR | Description of the rating |
|---|---|
| 1 point | Almost complete coverage, no vision of the paper board |
| 2 point | Mostly covered, vague vision of the paper board |
| 3 point | Partially covered, slightly clear vision of the paper board |

A black pigment base formulation was prepared by adding 100 g of glass bead (with an average diameter of 2 mm), 40 g of Sable® 6500, 24.7 g of Joncryl® HPD 196MEA, 0.3 g FoamStar® SI 2250 and 35 g of DI-water into a bottle. Then, the bottle was put into a high speed shaker and shook at a speed of 600 osc/min for 2 h. Finally, the mixture was filtered to remove glass bead.

A black ink was formulated by mixing 37.5 g of the black pigment base formulation as prepared above, 46.2 g of the aqueous core-shell polymer emulsion as prepared (with a solid content of 48 wt %) in the above Examples, 0.3 g of FoamStar® SI 2250, 4 g of Joncryl® Wax 26, 6 g of Joncryl® HPD 196MEA and 6 g of DI-water was mixed in a bottle. The mixture was stirred for 10 min at a speed of 400 rpm.

Color Strength Rating (CSR)

To prepare a film of the black ink:
1) Use a hand-proofer with a 180-mesh metal roller to apply the ink onto a corrugated paper board;
2) Put the printed paper board in an oven for 1 min at 50 deg C.

Color strength performance was rated by visual evaluation according to the following rating criteria. Each test result was evaluated independently by two different technical experts and an average was taken as the rating score.

TABLE 2

| CSR | Description of the rating |
|---|---|
| 3 point | Ink shows dark black color |
| 2 point | Ink shows dark color with some pale white color |
| 1 point | Ink shows some pale black color |

According to the data in Table 3, emulsions with vinyl acetate show better CPR and CSR than those without. And, inks formulated with emulsions containing vinyl acetate show better CSR than those formulated with emulsions without vinyl acetate. In addition, the weight ratio of vinyl acetate in the shell polymers can vary in a large range and still keep the technical benefits.

Data Summary

TABLE 3

| | | wt % | | Tg of | Tg of | Particle | | |
|---|---|---|---|---|---|---|---|---|
| | | of | Shell | shell | Core | Size | | |
| Ex | Shell Monomers | Vae^{*} | wt %^{**} | (deg C.) | (deg C.) | (nm) | CPR | CSR |
| 1 | Vae/BA/AA/VS | 70 | 41 | 11 | 88 | 179 | 3 | 3 |
| 2 | Vae/BA/AA/VS | 74 | 41 | 8 | 89 | 143 | 3 | 3 |
| 3 | Vae/BA/AA/VS | 70 | 34 | 26 | 98 | 257 | 3 | 3 |
| 4 | Vae/EA/AA/VS | 74 | 30 | 40 | 103 | 242 | 3 | 3 |
| 5 | Vae/EA/AA/VS | 70 | 34 | 38 | 101 | 195 | 3 | 3 |
| 6 | Vae/EA/AA/VS | 71 | 31 | 30 | 99 | 155 | 3 | 3 |
| 7 | Vae/EA/AA/VS | 53 | 20 | 18 | 99 | 143 | 3 | 3 |
| 8 | Vae/EA/BA/AA/VS | 64 | 23 | 39 | 101 | 140 | 3 | 3 |
| 9 | Vae/EA/Am/AA/VS | 73 | 33 | 32 | 97 | 167 | 3 | 3 |
| 10 | Vae/MA/BA/AA/VS | 38 | 23 | 25 | 104 | 163 | 3 | 3 |
| 11 | MMA/MA/AA/VS | N.A. | 29 | 29 | 101 | 111 | 1 | 1 |
| 12 | MMA/MA/BA/AA | N.A. | 24 | 24 | 98 | 121 | 1 | 1 |
| 13 | MMA/MA/BA/AA | N.A. | 24 | 20 | 100 | 122 | 1 | 1 |
| 14 | MMA/MA/BA/AA/VS | N.A. | 25 | 25 | 98 | 175 | 2 | 2 |

^{*}wt% of VAE means the weight percentage of Vae over the total weight of shell monomers and chain transfer agent.
^{**}Shell wt% means the weight percentage of the total weight of shell monomers (including the chain transfer agent) over the total weight of core and shell monomers (including the chain transfer agent).
N.A. means not applicable.

However, the present invention is not to be limited in scope by the specific embodiments and examples described herein. Indeed, various modifications of the invention in addition to those described herein will become apparent to those skilled in the art from the foregoing description. Such modifications are intended to fall within the scope of the appended claims.

1. A core-shell polymer comprising:
a. At least a core polymer, which is obtainable with at least 70 wt % styrene, based on the total weight of the monomers for the core polymer;
b. At least a shell polymer, which is obtainable with 20 wt % to 95 wt % vinyl esters, based on the total weight of the monomers for the shell polymer.

2. The core-shell polymer according to claim 1, wherein the core-shell polymer has a core:shell ratio (in weight) in the range of 90:10 to 45:55.

3. The core-shell polymer according to claim 1, wherein the core polymer has a Tg in the range of +60 to +120 deg C.

4. The core-shell polymer according to claim 1, wherein the shell polymer has a Tg in the range of −30 to +90 deg C.

5. The core-shell polymer according to claim 1, wherein the core-shell polymer has a particle size in the range of 100 to 300 nm.

6. The core-shell polymer according to claim 1, wherein the styrene for the core polymer is un-substituted styrene.

7. The core-shell polymer according to claim 1, wherein the vinyl ester for the shell polymer is vinyl acetate.

8. The core-shell polymer according to claim 1, wherein the shell polymer further contains at least one more hydrophilic monomer.

9. The core-shell polymer according to claim 8, wherein the at least one more hydrophilic monomer is acrylic acid, methacrylic acid, acrylamide or a mixture thereof.

10. The core-shell polymer according to claim 8, wherein the at least one more hydrophilic monomer is in an amount of 0.1 to 20 wt %, all based on the total amount of monomers used for the shell polymer.

11. The core-shell polymer according to claim 1, wherein the core polymer is obtainable with at least one hydrophobic co-monomer selected from the group consisting of (meth)acrylate monomers, (meth)acrylonitrile monomers, and monoethylenically unsaturated di- and tricarboxylic esters.

12. The core-shell polymer according to claim 1, wherein the shell polymer is obtainable with at least one hydrophobic co-monomer selected from the group consisting of (meth)acrylate monomers, (meth)acrylonitrile monomers, and monoethylenically unsaturated di- and tricarboxylic esters.

13. The core-shell polymer according to claim 1, wherein the polymer is obtained with at least one chain transfer agent and the total amount of the chain transfer agent is in an amount of 0.01 to 5 wt %, based on the amount of the all monomer(s) to be polymerized.

14. The core-shell polymer according to claim 13, wherein the chain transfer agent is selected from the group consisting of tetrabromomethane; alcohols, C2-8-ketones, mercaptans, thioglycolic acid, 2-ethylhexyl thioglycolate, mercaptoethanol, octyl thioglycolate, and mercaptoacetates.

15. A method for making a core-shell polymer according to claim 1, wherein the method includes polymerization of at least a first polymer containing vinyl esters first and at least a second polymer containing styrene.

16. A method of using the core-shell polymer according to claim 1, the method comprising using the core-shell polymer as a binder for ink.

17. The core-shell polymer according to claim 1, wherein the core-shell polymer comprises:
a. At least a core polymer, which is obtainable with at least 80 wt % styrene, based on the total weight of the monomers for the core polymer;
b. At least a shell polymer, which is obtainable with 20 wt % to 90 wt % vinyl esters, based on the total weight of the monomers for the shell polymer.

18. The core-shell polymer according to claim 1, wherein the core-shell polymer has a core:shell ratio (in weight) in the range of 85:15 to 45:55.

19. The core-shell polymer according to claim 1, wherein the core polymer has a Tg in the range of +70 to +120 deg C.

20. The core-shell polymer according to claim 1, wherein the shell polymer has a Tg in the range of −20 to +80 deg C.
